(19) United States
(12) Patent Application Publication
(10) Pub. No.: US 2009/0002863 A1
(43) Pub. Date: Jan. 1, 2009

(54) SYSTEM AND METHOD OF MONITORING DATA OPERATIONS AT A DATA STORAGE DEVICE

(75) Inventors: Timothy Richard Feldman, Louisville, CO (US); Edwin Scott Olds, Fort Collins, CO (US)

Correspondence Address: SEAGATE TECHNOLOGY LLC C/O WESTMAN;CHAMPLIN & KELLY, P.A., SUITE 1400, 900 SECOND AVENUE SOUTH, MINNEAPOLIS, MN, 55402-3244, US

(73) Assignee: SEAGATE TECHNOLOGY, LLC, Scotts Valley, CA (US)

(21) Appl. No.: 11/771,002

(22) Filed: Jun. 29, 2007

(51) Int. Cl. G11B 5/09

(52) U.S. Cl. 360/48

(57) ABSTRACT

Systems and methods of monitoring data operations at a data storage device are disclosed. In an embodiment, a first read access request to access first data and a second read access request to access second data may be determined. A first physical block address containing the first data and a second physical block address containing the second data may be determined. The first physical block address and the second physical block address may not be located contiguously. The first data and the second data may be stored in contiguous physical block addresses.

### FIELD OF THE DISCLOSURE

The present disclosure is generally related to monitoring data operations at data storage devices.

### BACKGROUND

Many factors may affect a user's experience with an electronic device. The speed that data can be retrieved from a memory can limit the operating speed of the electronic device, and thus may affect the user's experience. For example, portable devices can be configured to hibernate during periods of inactivity to extend battery life. However, when a user is ready to resume using a portable device, an extended delay in retrieving data from memory to restore the device to a pre-hibernation state can negatively impact the user's experience. Hence, there is a need for an improved system and method of monitoring data operations at data storage devices.

### BRIEF DESCRIPTION OF THE DRAWINGS

FIG. 1 is a cutaway view of an illustrative embodiment of a disc drive;

FIG. 2 is a block diagram of an illustrative embodiment of a disc drive system;

FIG. 3 is a diagram of a particular illustrative embodiment of a system to monitor data operations at a data storage device;

FIG. 4 is a flow diagram of a particular illustrative embodiment of a method of monitoring data operations at a data storage device; and

FIG. 5 is a flow diagram of another illustrative embodiment of a method of monitoring data operations at a data storage device.

### DETAILED DESCRIPTION OF THE DRAWINGS

In an embodiment, a method is disclosed that includes determining a first read access request to access first data stored in a memory and a second read access request to access second data stored in the memory. The method may include determining a first physical block address containing the first data. The method may also include determining a second physical block address containing the second data. The first physical block address and the second physical block address may not be located contiguously. The method may further include storing the first data and the second data in contiguous physical block addresses.

In another embodiment, a method is disclosed that includes receiving a first write request to write first data to a data storage device. The method may also include receiving a second write request to write second data to the data storage device. The method may include storing the first data at a first physical block address (PBA) of a first data storage medium. The method may further include storing the second data at a second PBA of the first data storage medium. At least one of the first PBA and the second PBA may be determined based on an order of a first sequence number associated with the first write request and a second sequence number associated with the second write request.

In another embodiment, a device is disclosed that includes a first data storage medium and a controller adapted to store data in the first data storage medium. The device may also include a memory accessible by the controller. The memory may include instructions to cause the controller to execute a method. The method may include writing first data to a first physical block address (PBA) of the first data storage medium and second data to a second PBA proximate to the first PBA based on an expected sequence of read access requests for the first data and the second data.

In another embodiment, a computer readable medium is disclosed that has instructions to cause a processor to execute a method. The method may include determining a first read access request to access first data stored in a memory and a second read access request to access second data stored in the memory. The method may include determining a first physical block address containing the first data. The method may include determining a second physical block address containing the second data. The first physical block address and the second physical block address may not be located contiguously. The method may further include storing the first data and the second data in contiguous physical block addresses based on an expected sequence of read access requests.

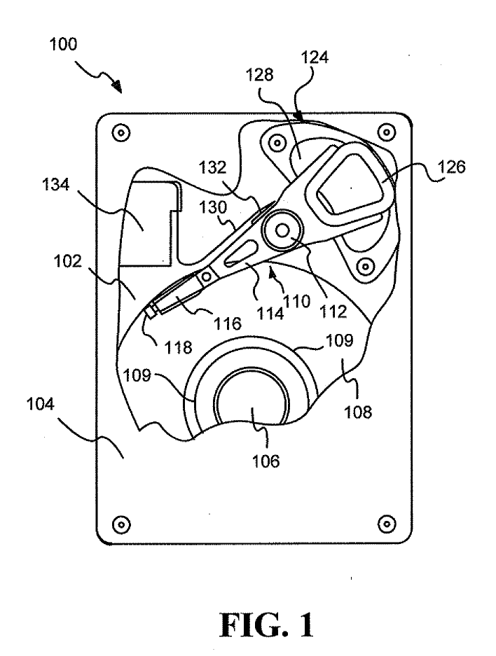

Referring to FIG. 1, in a particular embodiment, a disc drive 100 includes a base 102 to which various components of the disc drive 100 are mounted. A top cover 104, shown partially cut away, cooperates with the base 102 to form an internal, sealed environment for the disc drive. The components of the disc drive 100 include a spindle motor 106, which rotates at least one disc 108. Information is written to and read from tracks on the disc 108 through the use of an actuator assembly 110 that rotate about a bearing shaft assembly 112 positioned adjacent the discs 108. The actuator assembly 110 includes one or more actuator arms 114 that extend toward the disc 108, with one or more flexures 116 extending from the actuator arms 114. Mounted at the distal end of each of the flexures 116 is a head 118 including an air bearing slider (not shown) that enables the head 118 to fly in close proximity above the corresponding surface of the disc 108.

The track position of the heads 118 is controlled, during a seek operation, through the use of a voice coil motor (VCM) 124 that typically includes a coil 126 attached to the actuator assembly 110, as well as one or more permanent magnets 128 that establish a magnetic field in which the coil 126 is immersed. The controlled application of current to the coil 126 causes magnetic interaction between the permanent magnets 128 and the coil 126 so that the coil 126 moves in accordance with the well-known Lorentz relationship. As the coil 126 moves, the actuator assembly 110 pivots about the bearing shaft assembly 112, and the heads 118 are caused to move across the surfaces of the disc 108.

A flex assembly 130 provides requisite electrical connection paths for the actuator assembly 110 while allowing pivotal movement of the actuator assembly 110 during operation. The flex assembly 130 can include a printed circuit board 132 to which head wires (not shown) are connected. The head wires may be routed along the actuator arms 114 and the flexures 116 to the heads 118. The printed circuit board 132 may include circuitry for controlling the write currents applied to the heads 118 during a write operation and a preamplifier (not shown) for amplifying read signals generated by the heads 118 during a read operation. The flex assembly 130 terminates at a flex bracket 134 for communication through the base 102 to a disc drive printed circuit board (not shown) mounted to the disc drive 100.

As shown in FIG. 1, a plurality of nominally circular, concentric tracks 109 are located on the surface of the disc 108. Each track 109 includes a number of servo fields that are interspersed with user data fields along the track 109. The user data fields are used to store user data, and the servo fields are used to store servo information used by a disc drive servo system to control the position of the heads 118.

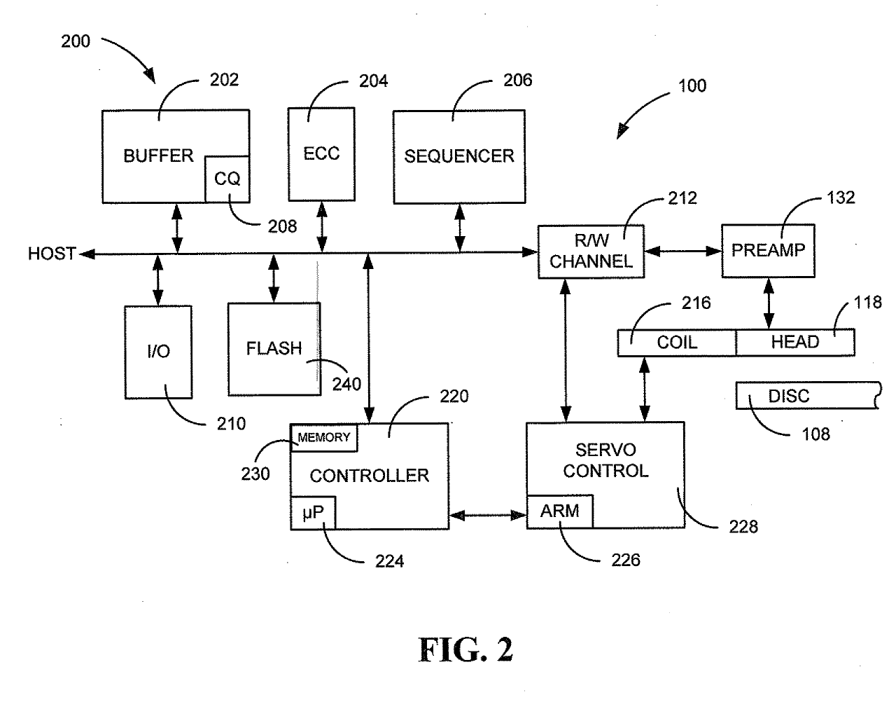

FIG. 2 provides a functional block diagram of the disc drive 100. A hardware/firmware based interface circuit 200 communicates with a host device (such as a personal computer, not shown) and directs overall disc drive operation. The interface circuit 200 includes a programmable controller 220 with associated microprocessor 224 and memory 230. In a particular embodiment, memory 230 is a first-in-first-out (FIFO) buffer. The interface circuit 200 also includes a buffer 202, an error correction code (ECC) block 204, a sequencer 206, and an input/output (I/O) control block 210.

The buffer 202 temporarily stores user data during read and write operations, and includes a command queue (CQ) 208 where multiple pending access operations are temporarily stored pending execution. The ECC block 204 applies on-the-fly error detection and correction to retrieved data. The sequencer 206 asserts read and write gates to direct the reading and writing of data. The I/O block 210 serves as an interface with the host device.

FIG. 2 further shows the disc drive 100 to include a read/write (R/W) channel 212 which encodes data during write operations and reconstructs user data retrieved from the disc 108 during read operations. A preamplifier/driver circuit (preamp) 132 applies write currents to the heads 118 and provides pre-amplification of readback signals.

A servo control circuit 228 uses servo data to provide the appropriate current to the coil 216 to position the heads 118. The controller 220 communicates with a processor 226 to move the heads 118 to the desired locations on the disc 108 during execution of the various pending commands in the command queue 208.

In a particular embodiment, a solid state non-volatile memory device, such as a flash memory 240, may be configured to provide an additional data storage medium. In a particular embodiment, the solid state non-volatile memory device may have a smaller storage capacity with a faster access time than the disc 108. In a particular embodiment, the solid state non-volatile memory device may be a random access storage device.

In a particular embodiment, the memory 230 of the controller 220 may be configured to include data and instructions that are executable by the microprocessor 224. In a particular embodiment, the controller 220 may be configured to receive access operations, such as data read requests and write requests, having associated logical block addresses (LBAs). The controller 220 may be configured to locate a physical block address (PBA) of the disc 1 08 or the flash memory 240 that corresponds to an LBA. For example, the controller 220 may be configured to maintain or access a LBA-to-PBA mapping table stored at the memory 230.

In a particular embodiment, the controller 220 may be configured to detect sequences of received data read requests. In a particular embodiment, the controller 220 may be configured to use the memory 230 to store logical block address (LBA) access data. The LBA access data may be stored in a manner such that historical sequences of data read requests are identifiable. In a particular embodiment, the controller 220 may be configured to detect and to store one or more LBA access patterns that correspond to previous sequences of data read requests, write requests, or any combination thereof.

In a particular embodiment, the controller 220 may be configured to receive LBA access data via a modified Directed Offline Scan technique that counts read accesses to a range of logical locations with count aging to identify most recently and most frequently used blocks. In a particular embodiment, the controller 220 may be configured to perform cache replacement techniques, such as least recently used (LRU), least frequently used (LFU), other operations, or any combination thereof, to determine LBA access activity. In a particular embodiment, the controller 220 may be configured to create, modify, or supplement one or more lists of LBAs using the determined LBA access activity.

In a particular embodiment, the controller 220 may be configured to determine an expected order of data read requests. For example, the controller 220 may receive information from the host device indicating an expected order of future data read requests. As another example, the controller 220 may be configured to analyze the LBA access data to predict a relationship between data read or write requests for two or more LBAs, based on historical data access operations.

In a particular embodiment, the controller 220 may be configured to write data to the disc 108 based on an expected order of data read request or write request for the data. For example, when a read request for a second LBA is predicted to closely follow a read request for a first LBA, data associated with the second LBA may be stored at the disc 108 at a physical block address (PBA) that is adjacent or in close proximity to a PBA associated with the first LBA. Thus, if a request to read data at the first LBA is immediately followed by a request to read data at the second LBA, a continuous read operation at first and second PBAs may be performed without repositioning the heads 118.

In a particular embodiment, the controller 220 may be configured to perform read ahead pre-fetching of data when a read is performed at the disc 108. When data is read from a particular PBA, data may also be read from one or more nearby PBAs in a continuous read operation and cached at the buffer 202. When a read request for first data is expected to be followed by a read request for second data, the controller 220 may store the second data at a PBA that will be pre-fetched when the first data is read.

In a particular embodiment, the controller 220 may be configured to store data at the disc 108 to improve data access performance based on an expected sequence of read requests. In a particular embodiment, the controller 220 may be configured to determine whether an expectation of read access requests satisfies one or more conditions before relocating data on the disc 108. For example, the controller 220 may only relocate data B proximal to data A when the last four or more data B read requests immediately followed data A read requests. As another example, the controller 220 may only relocate data B proximal to data A when at least 75% of data B read requests are received within a particular time limit or within a certain number of requests after receiving data A read requests. Similarly, the controller 220 may be configured to store data at the disc 108 based on an expected sequence of write requests.

The controller 220 may be configured to write or transfer data based on the expected access sequence only under certain conditions. For example, the controller 220 may be configured to store data to a new PBA only when data write requests are received. As another example, the controller 220 may be configured to relocate stored data based on expected data access sequences only during periods of reduced or minimal data access activity at the disc 108.

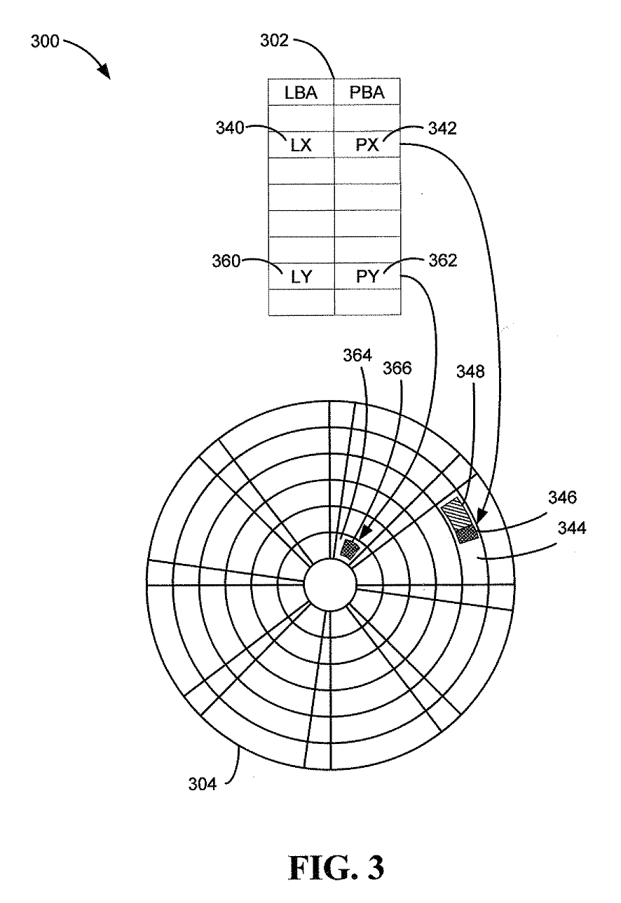

Referring to FIG. 3, an embodiment of a system to monitor logical block address activity is depicted and generally designated 300. The system 300 includes a table 302 to map logical block addresses (LBAs) to physical block addresses (PBAs) corresponding to a storage medium 304. In a particular embodiment, storage medium 304 may be the disc 108 shown in FIG. 1 and FIG. 2.

In a particular embodiment, first data 346 may be stored at a first portion 344 of the storage medium 304. The first data 346 may be accessed by a host device or other system via a request including a first LBA “LX.” The table 302 may be searched for the entry “LX” 340, and a corresponding PBA “PX” 342 may be determined. PX may identify the first portion 344 to enable access to the first data 346. Similarly, a request for second data 366 including a second LBA “LY” may result in a search of the table 302 for the entry “LY” 360, and a corresponding PBA “PY” 362 may identify a second portion 364 of the storage medium 304 having the second data 366.

In a particular embodiment, it may be determined that the first LBA “LX” is frequently accessed immediately before the second LBA “LY” is accessed. Data access may therefore be improved by moving the second data 366 to a location 348 that is in closer proximity to the first PBA “PX.” In a particular embodiment, the location 348 may include the next sequential PBA encountered by a head after PX is accessed. In a particular embodiment, the location 348 may indicate a range of PBAs that are accessed during a read ahead pre-fetching that is performed when PX is accessed.

Although the first portion 344 and the second portion 364 of the storage medium 304 are depicted as sectors of a single disc, it should be understood that the system 300 may include any type of storage medium or combination of one or more types of storage media. As an example, one or more of the portions 344 and 364 may be non-volatile solid-state storage media, such as Dynamic Random Access Memory (DRAM) or flash memory, or optical storage media, other magnetic storage media, any other type of media that can store data, or any combination thereof Further, in a particular embodiment, the table 302 may associate multiple LBAs to a single PBA, or a single LBA to multiple PBAs, or both.

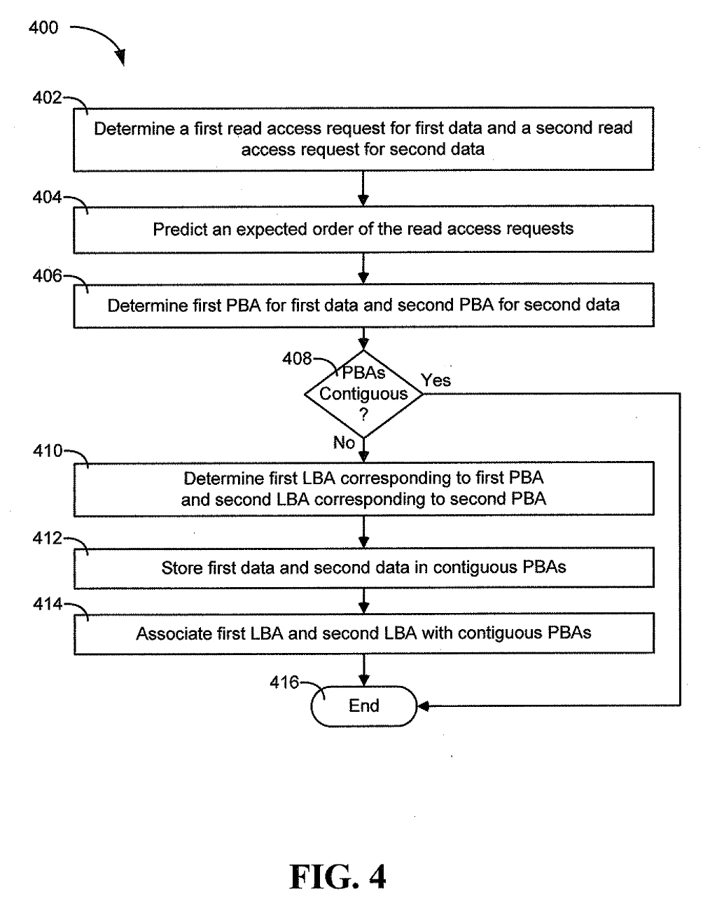

Referring to FIG. 4, a flow diagram of an embodiment of a method of monitoring data operations at a data storage device is depicted and generally designated 400. A first read access request for first data and a second read access request for second data may be determined, at 402. The read access requests may be received at a controller of the data storage device, such as the controller 220 of FIG. 2.

In a particular embodiment, an expected order of the first read access request and the second read access request may be predicted, at 404. The expected order may be predicted based on previous read access requests. In a particular embodiment, a first sequence number may be assigned to the first read access request and a second sequence number may be assigned to the second read access request.

A first physical block address (PBA) containing the first data and a second PBA containing the second data may be determined, at 406. When the first PBA and the second PBA are located contiguously, at 408, the method may end, at 416. Otherwise, in a particular embodiment, a first logical block address (LBA) associated with the first read access and a second LBA associated with the second read access may be determined, at 410. The first LBA may correspond to the first PBA containing the first data, and the second LBA may correspond to the second PBA containing the second data.

The first data and the second data may be stored in contiguous PBAs, at 412. In a particular embodiment, the first data and the second data may be stored in the contiguous PBAs according to the first sequence number and the second sequence number. In a particular embodiment, the first and second LBAs may be associated with the contiguous PBAs, at 414. The method may end, at 416.

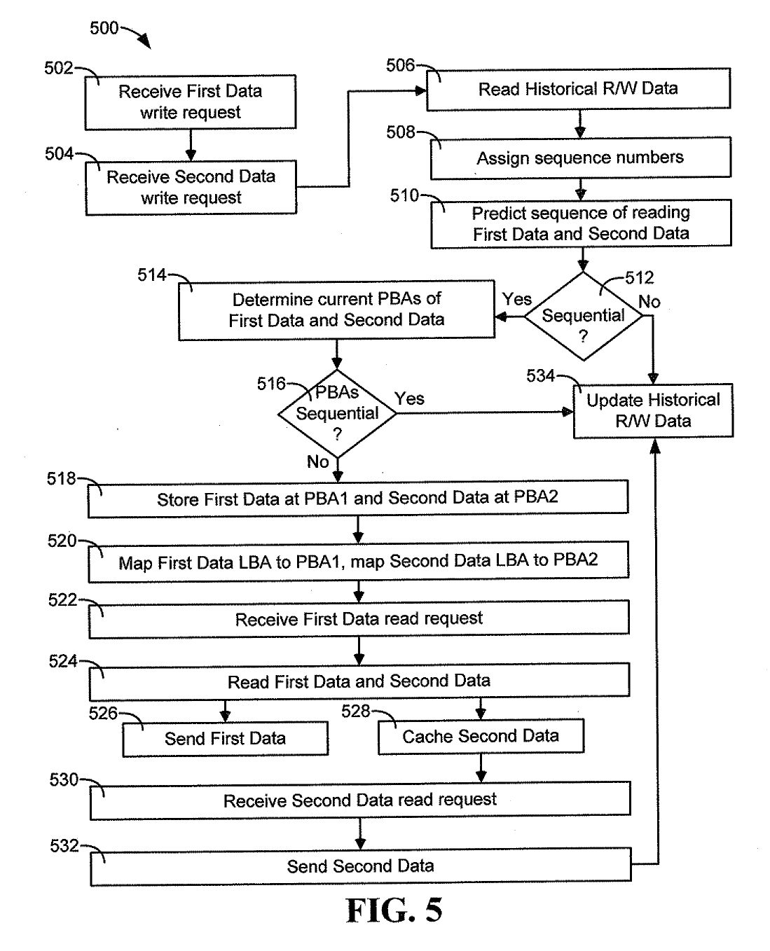

Referring to FIG. 5, a flow diagram of an embodiment of a method of monitoring data operations at a data storage device is depicted and generally designated 500. A first write request to write first data to a data storage device may be received, at 502. A second write request to write second data to the data storage device may be received, at 504. In a particular embodiment, the write requests may be received at an internal controller of the data storage device, such as the controller 220 of FIG. 2.

In a particular embodiment, historical data of previous read requests, write requests, or any combination thereof, may be read by the internal controller of the data storage device, at 506. A first sequence number associated with the first data write request and a second sequence number associated with the second data write request may be assigned, at 508. In a particular embodiment the first sequence number and the second sequence numbers may be determined based on an order of previous read access requests, an order of the first and second write requests, or any combination thereof. The sequence numbers may be determined by the internal controller, received from an external host system that is coupled to the data storage device, or any combination thereof.

A sequence of read request for the first data and the second data may be predicted, at 510. As an illustrative, non-limiting example, if the first sequence number is 1 and the second sequence number is 2, then a read request for the first data may be predicted to be received immediately before a read request for the second data. If the first data and the second data are not predicted to be sequentially read, at 512, the historical data may be updated to include the first write request and the second write request, at 534.

When the first data and the second data are predicted to be sequentially read, at 512, the current physical block addresses (PBAs) of the first data and the second data may be determined, at 534. If the current PBAs are already in a configuration that enables efficient data access based on the predicted sequence, such as being sequentially located, at 516, the historical data may be updated to include the first write request and the second write request, at 534.

When the current PBAs are not in a configuration that enables efficient data access based on the predicted sequence, at 516, the first data may be stored at a first PBA of a first data storage medium, such as the disc 108 of FIGS. 1-2, and the second data may be stored at a second PBA of the first data storage medium, at 518. At least one of the first PBA and the second PBA may be determined based on an order of the first sequence number and the second sequence number. In a particular embodiment, the first PBA and the second PBA may be contiguous.

In a particular embodiment, the first write request may be associated with a first logical block address (LBA) and the second write request may be associated with a second LBA. At least one of the first LBA and the second LBA may be mapped to the first PBA, the second PBA, or both, that was determined based on the order of the first sequence number and the second sequence number, at 520. The mapping may be performed at a table such as table 302 of FIG. 3.

In a particular embodiment, a first read access request to access the first data may be received, at 522. The first data may be read from the first PBA in response to the first read access request. In addition, the second data may also be read when the first data is read from the first PBA, at 524. For example, the data storage device may be configured to perform read ahead pre-fetching of at least one physically proximate sector at the first data storage medium, and the second PBA may be selected to be within a sector that is pre-fetched when the first data is read.

The first data may be sent in response to the read request, at 526, while the second data may be stored at a second data storage medium of the data storage device, at 528, such as at the buffer 202 or the flash memory 240 of FIG. 2. After the first read access request is received, a second read access request may be received to access the second data, at 530. The second data may be provided from the second data storage medium, at 532, rather than from the first data storage medium. The historical data may be updated to include the first read request and the second read request, at 534.

In accordance with various embodiments, the methods described herein, including but not limited to the methods depicted in and described in accordance with FIGS. 4-5, may be implemented as one or more software programs executable by a controller accessible to a data storage device. The data storage device may be a solid-state data storage device, such as a flash data storage device. The solid-state data storage device may be non-volatile or volatile. Also, the data storage device may be an optical data storage device, a magneto-optical data storage device, any other type of known or future developed data storage device, or any combination of types of data storage devices. Further, the data storage device may be a hybrid data storage device having more than one type of data storage medium.

In accordance with various embodiments, the methods described herein may be implemented as one or more software programs running on a computer processor or controller, such as the controller 220. In accordance with another embodiment, the methods described herein may be implemented as one or more software programs running on a host device, such as a PC that is using a disc drive. Dedicated hardware implementations including, but not limited to, application specific integrated circuits, programmable logic arrays and other hardware devices can likewise be constructed to implement the methods described herein.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract of the Disclosure is provided to comply with 37 C.F.R. §1.72(b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present invention. Thus, to the maximum extent allowed by law, the scope of the present invention is to be determined by the broadest permissible interpretation of the following claims and their equivalents, and shall not be restricted or limited by the foregoing detailed description.

What is claimed is:

1. A method comprising:
determining a first read access request to access first data stored in a memory and a second read access request to access second data stored in the memory;
determining a first physical block address containing the first data;
determining a second physical block address containing the second data;
wherein the first physical block address and the second physical block address are not located contiguously; and
storing the first data and the second data in contiguous physical block addresses.

2. The method of claim 1, further comprising:
predicting an expected order of the first read access request and the second read access request.

3. The method of claim 2, wherein the expected order is predicted based on previous read access requests.

4. The method of claim 1, further comprising:
assigning a first sequence number to the first read access request and a second sequence number to the second read access request; and
wherein the first data and the second data are stored in contiguous physical block addresses according to the first sequence number and the second sequence number.

5. The method of claim 1, further comprising:
determining a first logical block address associated with the first read access, the first logical block address corresponding to the first physical block address containing the first data; and
determining a second logical block address associated with the second read access, the second logical block address corresponding to the second physical block address containing the second data.

6. The method of claim 5, further comprising:
associating the first and second logical block addresses with the contiguous physical block addresses.

7. A method, comprising:
receiving a first write request to write first data to a data storage device;
receiving a second write request to write second data to the data storage device;
storing the first data at a first physical block address (PBA) of a first data storage medium;
storing the second data at a second PBA of the first data storage medium;
wherein at least one of the first PBA and the second PBA are determined based on an order of a first sequence number associated with the first write request and a second sequence number associated with the second write request.

8. The method of claim 7, further comprising:
receiving a first read access request to access the first data;
reading the second data when the first data is read from the first PBA; and
storing the second data at a second data storage medium of the data storage device.

9. The method of claim 8, wherein the data storage device is configured to perform read ahead pre-fetching of at least one physically proximate sector at the first data storage medium, and wherein the second PBA is selected to be within a sector that is pre-fetched when the first data is read.

10. The method of claim 8, further comprising:
receiving a second read access request to access the second data, the second read access request received after the first read access request; and
providing the second data from the second data storage medium.

11. The method of claim 7, wherein the first PBA and the second PBA are contiguous.

12. The method of claim 11, wherein the first write request is associated with a first logical block address (LBA) and the second write request is associated with a second LBA, and further comprising:
mapping at least one of the first LBA and the second LBA to the at least one of the first PBA and the second PBA that is determined based on the order of the first sequence number and the second sequence number.

13. The method of claim 7, wherein the first sequence number and the second sequence number are received from an external host system that is coupled to the data storage device.

14. The method of claim 13, wherein the first sequence number and the second sequence number are determined by an internal controller of the data storage device.

15. The method of claim 14, wherein the first sequence number and the second sequence number are determined based on an order of previous read access requests.

16. The method of claim 15, wherein the first sequence number and the second sequence number are further based on an order of the first write request and the second write request.

17. A device comprising:
a first data storage medium;
a controller adapted to store data in the first data storage medium; and
a memory accessible by the controller, the memory including instructions to cause the controller to execute a method comprising:
writing first data to a first physical block address (PBA) of the first data storage medium and second data to a second PBA proximate to the first PBA based on an expected sequence of read access requests for the first data and the second data.

18. The device of claim 17, wherein the method further comprises:
determining the expected sequence of read access requests includes a first read access request for the first data before a second read access request for the second data; and
selecting the second PBA to reduce an access time to the second data after the first data is read from the first PBA.

19. The device of claim 18, further comprising a second data storage medium having a faster access time than the first data storage medium, wherein the first data storage medium is a disc drive, and wherein the method further comprises:
receiving the first read access request;
reading the first data and the second data in a continuous data read operation when the first read access request is received; and
storing the second data at the second data storage medium.

20. The device of claim 18, wherein the method further comprises:
storing historical data corresponding to a plurality of previous data access requests; and
computing the expected sequence using the historical data.

21. The device of claim 17, wherein the first data storage medium is selected from the group consisting of a solid-state data storage medium, a magnetic data storage medium, an optical data storage medium, and a magneto-optical data storage medium.

22. A computer readable medium having instructions to cause a processor to perform a method comprising:
determining a first read access request to access first data stored in a memory and a second read access request to access second data stored in the memory;
determining a first physical block address containing the first data;
determining a second physical block address containing the second data;
wherein the first physical block address and the second physical block address are not located contiguously; and
storing the first data and the second data in contiguous physical block addresses based on an expected sequence of read access requests.

23. The computer readable medium of claim 22, wherein the method further comprises:
maintaining historical data of previous data operations at the memory; and
using at least a portion of the historical data to predict the expected sequence of read access requests.

24. The computer readable medium of claim 23, wherein the method further comprises:
updating a table that maps logical block addresses to physical block addresses based on storing the first data and the second data in the contiguous physical block addresses.

25. The computer-readable medium of claim 22, wherein the memory is selected from the group consisting of a solid-state data storage device, a magnetic data storage device, an optical data storage device, a magneto-optical data storage device, and a hybrid data storage device having more than one type of data storage medium.
